(19) United States
(12) Patent Application Publication
(10) Pub. No.: US 2008/0170628 A1
(43) Pub. Date: Jul. 17, 2008

(54) VIDEO DECODING METHOD AND APPARATUS HAVING IMAGE SCALE-DOWN FUNCTION

(75) Inventor: Soon-jae CHO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/760,808

(22) Filed: Jun. 11, 2007

(30) Foreign Application Priority Data
Jan. 17, 2007 (KR) 10-2007-0005420

(51) Int. Cl. H04N 11/02; H04N 5/45

(52) U.S. Cl. 375/240.25; 375/E07.226

(57) ABSTRACT

Provided are a video decoding method and apparatus having an image scale-down function that is adaptive to motion. The video decoding method includes decoding a compressed image using a decoding algorithm, performing anti-aliasing filtering on an intra block and an inter block of the decoded image, down-sampling the anti-aliasing filtered image at a first rate and storing the down-sampled image, and up-sampling the stored down-sampled image at a second rate in order to compensate for the motion of the decoded image.

### CROSS-REFERENCE TO RELATED PATENT APPLICATION

This application claims priority from Korean Patent Application No. 10-2007-0005420, filed on Jan. 17, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to video decoding, and more particularly, to video decoding having an image scale-down function that is adaptive to motion.

2. Description of the Related Art

Generally, a Picture-in-Picture (PIP) device displays an image having a smaller size than that of an input image. A related art video player having an image scale-down function has to scale down an output image signal that has been decoded according to a standard codec in order to obtain a scaled-down image. Thus, the related art video player further includes a scale-down block for the image scale-down function in addition to a video decoder. However, the related art video player having the scale-down block performs a scale-down process using image data stored in a frame buffer, increasing a memory size. In order to solve the problem, a video decoding method and apparatus having an image scale-down function is disclosed in U.S. Patent Application No. 2003081843, filed on Oct. 8, 2002 and entitled “Compression Video Decoder Including a Scale-down Function for Scaling down an Image, and Method thereof”.

FIG. 1 is a block diagram of a related art video decoder having an image scale-down function.

Referring to FIG. 1, the video decoder includes a header parser 102, a variable-length decoder 104, an inverse quantization (IQ) unit 106, an N×N inverse discrete cosine transform (IDCT) unit 108, an N×N motion compensation (MC) unit 112, and a frame buffer 114.

The header parser 102, the variable-length decoder 104, and the IQ unit 106 are generalized blocks used in a compression video decoder and extract IDCT coefficients from a compressed video stream. A general video decoder uses 8×8 block IDCT and 16×16 block MC. The N×N IDCT unit 108 takes only N×N block DCT coefficients according to an image scale-down rate among 8×8 block DCT coefficients and performs IDCT by multiplying each of the N×N block DCT coefficients by N/8. The N×N MC unit 112 uses a reference image that has undergone IDCT and a current image and performs MC with a vector size and an MC range that are reduced at a rate of N/8.

However, the related art video decoder as illustrated in FIG. 1 takes only N×N block DCT coefficients in a low-frequency domain among 8×8 DCT coefficients and discards DCT coefficients in a high-frequency domain. As a result, an image decoded by the related art video decoder has poor high-frequency characteristics and serious degradation in display quality occurs in edge portions of the decoded image.

### SUMMARY OF EXEMPLARY EMBODIMENTS OF THE INVENTION

The present invention provides a video decoding method having an image scale-down function that is adaptive to motion by dividing a decoded image signal into an intra block and an inter block and performing anti-aliasing filtering on the intra block and the inter block.

The present invention also provides a video decoding apparatus having an image scale-down function that is adaptive to motion by performing anti-aliasing filtering on the intra block and the inter block.

The present invention also provides a display method for a video decoding system having a motion-adaptive function.

According to one aspect of the present invention, there is provided a video decoding method including decoding a compressed image using a predetermined decoding algorithm, selectively performing anti-aliasing filtering on an intra block and an inter block of the decoded image, down-sampling the anti-aliasing filtered image at a predetermined rate and storing the down-sampled image, and up-sampling the stored down-sampled image at a predetermined rate in order to compensate for the motion of the decoded image.

According to another aspect of the present invention, there is provided a video decoding method including decoding a compressed image using a predetermined decoding process, compensating for the motion of the decoded image using a motion vector and an image of a reference frame, performing anti-aliasing filtering on an intra block and an inter block of the decoded image, down-sampling the anti-aliasing filtered image or the decoded image at a predetermined rate, and storing the down-sampled image in a buffer and up-sampling the stored down-sampled image at a predetermined rate in order to generate a reference image for motion compensation.

According to another aspect of the present invention, there is provided a display method for a decoding system. The display method includes decoding a compressed image using a decoding process, compensating for the motion of the decoded image using a motion vector and an image of a reference frame, performing anti-aliasing filtering on an intra block and an inter block of the decoded image, scaling down the decoded image by down-sampling the anti-aliasing filtered image or the decoded image at a first rate, and storing the scaled-down image in a buffer in order to display the image on a screen and up-sampling the stored scaled-down image at a second rate in order to generate a reference image for motion compensation.

According to another aspect of the present invention, there is provided a video decoding apparatus including a variable-length decoding unit, an inverse discrete cosine transform (IDCT) unit, a motion compensation (MC) unit, an image scale processing unit, and a frame buffering unit. The variable-length decoding unit performs variable-length decoding on a compressed image in order to extract DCT coefficients and intraprediction/interprediction mode information. The IDCT unit transforms the extracted DCT coefficients into IDCT coefficients, thereby decoding the extracted DCT coefficients into an image signal. The MC unit compensates for the motion of an image decoded by the IDCT unit using a motion vector and a reference image generated by the variable-length decoding unit. The image scale processing unit selectively performs anti-aliasing filtering on the image output from the IDCT unit or the MC unit according to the intraprediction/interprediction information extracted by the variable-length decoding unit, down-samples the anti-aliasing filtered image, and up-samples the down-sampled image in order to generate the reference image. The frame buffering unit stores the image processed by the image scale processing unit.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art video decoder having an image scale-down function;

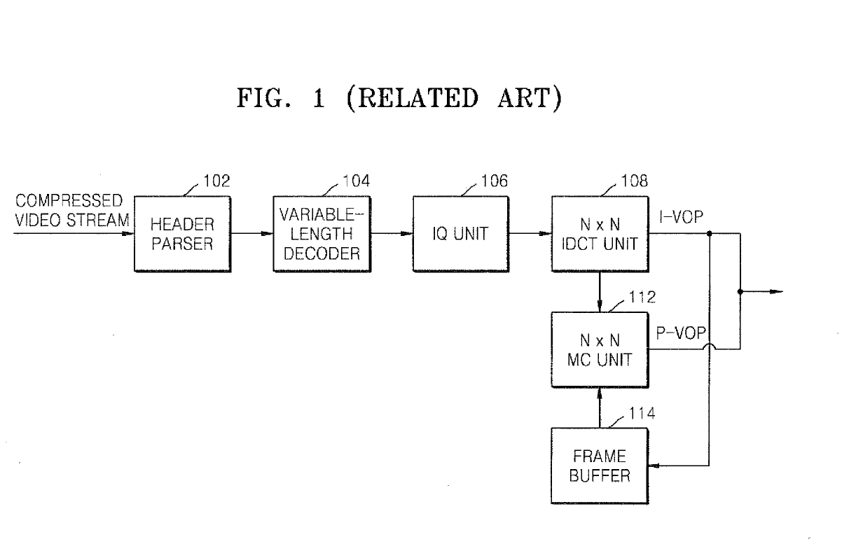

FIG. 2 is a block diagram of a video decoding apparatus having an image scale-down function according to an exemplary embodiment of the present invention; and

FIG. 3 is a flowchart of a video decoding method having an image scale-down function according to an exemplary embodiment of the present invention.

### DETAILED DESCRIPTION OF EXEMPLARY EMBODIMENTS OF THE INVENTION

Hereinafter, an exemplary embodiment of the present invention will be described in detail with reference to the accompanying drawings. It should be noticed that like reference numerals refer to like elements illustrated in one or more of the drawings. In the following description of the present invention, a detailed description of known functions and configurations incorporated herein will be omitted for conciseness and clarity.

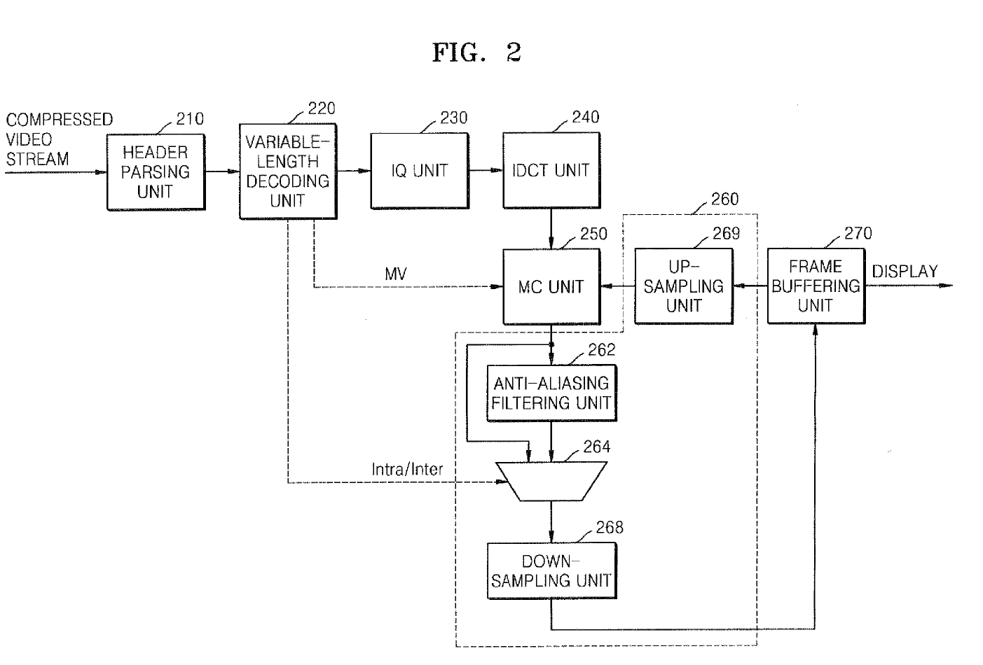

FIG. 2 is a block diagram of a video decoding apparatus having an image scale-down function according to an exemplary embodiment of the present invention.

The video decoding apparatus illustrated in FIG. 2 includes a header parsing unit 210, a variable-length decoding unit 220, an IQ unit 230, an IDCT unit 240, a MC unit 250, an image scale processing unit 260, and a frame buffering unit 270. The image scale processing unit 260 includes an anti-aliasing filtering unit 262, a multiplexing unit 264, a down-sampling unit 268, and an up-sampling unit 269.

The video decoding apparatus receives a compressed video stream that is output from a video encoding apparatus (not shown). The video encoding apparatus compresses an image signal. For compression, a block-based prediction process is performed on an input image signal. DCT and then quantization are performed on the predicted image signal. The quantized image signal undergoes variable-length coding together with motion vector estimation and motion compensation, thus being transformed into a bitstream. At this time, the prediction process may be performed by intra block prediction (or intraprediction) and/or inter block prediction (or interprediction) according to a picture type such as an intra (I) picture, a predictive (P) picture, or a bidirectional (B) picture. Inter block encoding involves encoding a differential image and a motion vector between a block of a previous frame and a block of a current frame. Intra block encoding involves encoding a block signal of a frame. Final encoded video data is output to the video decoding apparatus, together with compression data information, intra/inter prediction mode information, and motion vector information.

Referring back to FIG. 2, the header parsing unit 210 divides the compressed video stream into a header and a video stream and extracts video information such as an image size and a frame rate from the header.

The variable-length decoding unit 220 performs variable-length decoding on the compressed video stream divided by the header parsing unit 210, thereby generating block-based quantization DCT coefficients. The variable-length decoding unit 220 also generates block-based motion vector information and block-based prediction mode information. The prediction mode information may indicate an intra prediction mode or an inter prediction mode.

The IQ unit 230 performs IQ on the quantization DCT coefficients and the motion vector information which are generated by the variable-length decoding unit 220, thereby generating DCT coefficients.

The IDCT unit 240 decodes the DCT coefficients generated by the IQ unit 230 into an image signal or a differential image signal according to the prediction mode information. Preferably, the IDCT unit 240 performs IDCT on an 8×8 block basis. The differential image signal is generated during inter block encoding performed by the video encoding apparatus.

The MC unit 250 performs MC on a 16×16 block basis for each inter block and each intra block. In other words, for the inter block, the MC unit 250 adds an IDCT block generated by the IDCT unit 240 to a block of a previous frame (or a reference frame) indicated by a motion vector extracted by the variable-length decoding unit 220, thereby compensating for motion of the current block. For the intra block, an image of the IDCT block is not motion-compensated. Thus, for the intra block, the MC unit 250 passes an image of the IDCT block generated by the IDCT unit 240.

The anti-aliasing filtering unit 262 performs anti-aliasing filtering on a decoded image signal output from the MC unit 250 in order to prevent aliasing due to down-sampling of an image signal. The anti-aliasing unit 262 may be a decimation filter.

The MC unit 250 performs MC on an image of a reference frame using a motion vector. However, the image of the reference frame has already been anti-aliasing filtered by the anti-aliasing filter 262. Thus, the motion compensated image has already been anti-aliasing filtered by the anti-aliasing filter 262. A signal obtained by adding the IDCT image generated by the IDCT unit 240 to the image of the reference frame in the MC unit 250 is anti-aliasing filtered by the anti-aliasing filter 262 again. In other words, anti-aliasing filtering is performed twice. Generally, an image of a frame that is input prior to an I picture is continuously used as an image of a reference frame. Since the anti-aliasing filtered image is used as a reference image for a next image and a motion-compensated image of the anti-aliasing filtered image is also used as the reference image for the next image, anti-aliasing filtering is applied to an image signal cumulatively over time. Such cumulative application of the anti-aliasing filtering to the image signal may cause a loss of high-frequency components in an image. The image having lost its high-frequency components may suffer from display quality degradation. Thus, for an inter block, a reference block has already been anti-aliasing filtered and thus an image output from the MC unit 250 is merely down-sampled without being anti-aliasing filtered. For an intra block, a decoded image is anti-aliasing filtered in order to prevent aliasing.

Referring back to FIG. 2, the multiplexing unit 264 selects a decoded image output from the MC unit 250 or a decoded image output from the anti-aliasing filtering unit 262 according to whether the prediction mode information generated by the variable-length coding unit 220 indicates the intraprediction mode or the interprediction mode. In other words, the multiplexing unit 264 selects the decoded image that is output from the MC unit 250 for the interprediction mode and selects the decoded image that is output from the anti-aliasing filtering unit 262 for the intraprediction mode.

The down-sampling unit 268 sub-samples the decoded image selected by the multiplexing unit 264 at a desired scale rate, e.g., 16:N, in which 16 is the number of pixels and N is a scale size.

The frame buffering unit 270 stores an image signal of a frame that is sub-sampled by the down-sampling unit 268 and displays the sub-sampled image signal on a screen.

The up-sampling unit 269 up-samples the sub-sampled image signal stored in the frame buffering unit 270 at a predetermined rate, e.g., N:16. At this time, the up-sampled image signal is input to the MC unit 250 in order to be used as an image of a reference frame for MC. Preferably, but not necessarily, interpolation is used for up-sampling.

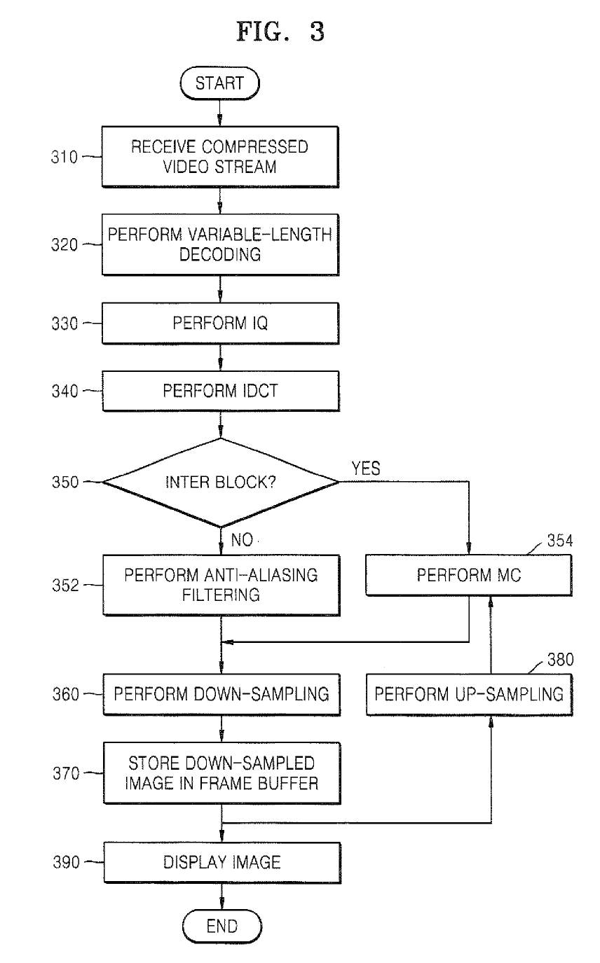

FIG. 3 is a flowchart of a video decoding method having an image scale-down function according to an exemplary embodiment of the present invention.

In operation 310, a compressed video stream is received from a video encoding apparatus.

In operation 320, variable-length decoding is performed on the compressed video stream in order to extract DCT coefficients and prediction mode information.

In operations 330 and 340, IQ and IDCT are performed on the DCT coefficients, thereby decoding the DCT coefficients to an image signal.

Next, a decoded image is divided into an intra block and an inter block and anti-aliasing filtering is selectively performed on the intra block and the inter block. In other words, it is checked if a current block is the inter block based on the prediction mode information extracted during the variable-length decoding, in operation 350. If a block is the inter block, anti-aliasing filtering is not applied to a decoded image and a reference image is added to the decoded image with reference to the motion vector, thereby compensating for the motion of the block in operation 354. If the block is the intra block, anti-aliasing filtering is applied to the decoded image in order to prevent aliasing, in operation 352.

The anti-aliasing filtered image or the motion-compensated image is down-sampled at a desired rate in operation 360.

The down-sampled image signal is stored in a frame buffer in operation 370.

At this time, the image signal stored in the frame buffer is up-sampled in operation 380 in order to be generated as a reference image for MC. For example, if the image signal stored in the frame buffer is scaled down at a rate of 16:N both in the horizontal direction and the vertical direction, MC is performed using a motion vector multiplied by N/16. The reference image is generated by interpolation at a rate of N:16. 16×16 MC is performed using the N:16 interpolated reference image. Image scaling down applies the same rate to the horizontal direction and the vertical direction of a predetermined block.

In operation 390, the image signal stored in the frame buffer is displayed on a screen.

The decoded image is divided into an intra block and an inter block and anti-aliasing filtering is selectively performed on the intra block and the inter block.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to an exemplary embodiment of the present invention, a video decoding apparatus scales down an image, thereby improving display quality and reducing a frame buffer capacity and a memory transmission bandwidth. For example, the frame buffer capacity can be reduced to (N×N)/(16×16). Moreover, image scaling down is performed by selectively applying anti-aliasing filtering to an intra block and an inter block instead of applying the anti-aliasing filtering to the entire image, thereby minimizing display quality degradation.

While the present invention has been particularly shown and described with reference to exemplary embodiments thereof, it will be understood by those of ordinary skill in the art that various changes in form and detail may be made therein without departing from the spirit and scope of exemplary embodiments of the present invention as defined by the following claims.

What is claimed is:

1. A video decoding method comprising:
decoding a compressed image using a decoding algorithm;
performing anti-aliasing filtering on an intra block and an inter block of the decoded image;
down-sampling the anti-aliasing filtered image at a first rate and storing the down-sampled image; and
up-sampling the stored down-sampled image at a second rate in order to compensate for the motion of the decoded image.

2. The video decoding method of claim 1, wherein the decoding algorithm is predetermined.

3. The video decoding method of claim 1, wherein the anti-aliasing filtering is selectively performed.

4. The video decoding method of claim 1, wherein the first rate and the second rate are predetermined.

5. The video decoding method of claim 1, wherein the decoding of the compressed image comprises performing variable-length decoding on the compressed image in order to extract discrete cosine transform (DCT) coefficients and prediction mode information, and transforming the DCT coefficients to inverse DCT (IDCT) coefficients, thereby decoding the DCT coefficients to an image signal.

6. The video decoding method of claim 3, wherein the selective performing of the anti-aliasing filtering comprises performing the anti-aliasing filtering on the intra block.

7. The video decoding method of claim 1, wherein the down-sampling comprises sub-sampling.

8. The video decoding method of claim 1, wherein the down-sampling of the anti-aliasing filtered image comprises performing the anti-aliasing filtering and then the down-sampling on a block if the block is the intra block and performing motion compensation and then the down-sampling on the block if the block is the inter block.

9. A video decoding method comprising:
decoding a compressed image using a decoding process;
compensating for the motion of the decoded image using a motion vector and an image of a reference frame;
performing anti-aliasing filtering on an intra block and an inter block of the decoded image;
down-sampling one of the anti-aliasing filtered image and the decoded image at a first rate; and
storing the down-sampled image in a buffer and up-sampling the stored down-sampled image at a second rate in order to generate a reference image for motion compensation.

10. The video decoding method of claim 9, wherein the decoding process is predetermined.

11. The video decoding method of claim 9, wherein the anti-aliasing filtering is selectively performed.

12. The video decoding method of claim 9, wherein the first rate and the second rate are predetermined.

13. The video decoding method of claim 9, wherein the up-sampling comprises interpolation.

14. The video decoding method of claim 11, wherein the selective performing of the anti-aliasing filtering comprises performing the anti-aliasing filtering only on the intra block without performing the anti-aliasing filtering on the inter block.

15. A display method for a decoding system, the display method comprising:
decoding a compressed image using a decoding process;
compensating for the motion of the decoded image using a motion vector and an image of a reference frame;
performing anti-aliasing filtering on an intra block and an inter block of the decoded image;
scaling down the decoded image by down-sampling one of the anti-aliasing filtered image and the decoded image at a first rate; and
storing the scaled-down image in a buffer in order to display the image on a screen and up-sampling the stored scaled-down image at a second rate in order to generate a reference image for motion compensation.

16. The display method of claim 15, wherein the decoding process is predetermined.

17. The display method of claim 15, wherein the first rate and the second rate are predetermined.

18. A video decoding apparatus comprising:
a variable-length decoding unit which performs variable-length decoding on a compressed image in order to extract discrete cosine transform (DCT) coefficients and intraprediction/interprediction mode information;
an inverse discrete cosine transform (IDCT) unit which transforms the extracted DCT coefficients into IDCT coefficients, thereby decoding the extracted DCT coefficients into an image signal;
a motion compensation (MC) unit which compensates for the motion of an image decoded by the IDCT unit using a motion vector generated by the variable-length decoding unit and a reference image;
an image scale processing unit which performs anti-aliasing filtering on the image output from the IDCT unit or the MC unit according to the intraprediction/interprediction information extracted by the variable-length decoding unit, down-samples the anti-aliasing filtered image, and up-samples the down-sampled image in order to generate the reference image; and
a frame buffering unit which stores the image processed by the image scale processing unit.

19. The video decoding apparatus according to claim 18, wherein the anti-aliasing filtering is selectively performed.

20. The video decoding apparatus of claim 19, wherein the image scale processing unit comprises:
an anti-aliasing filtering unit which performs anti-aliasing filtering on the decoded image;
a multiplexing unit which selects one of the anti-aliasing filtered image that is output from the anti-aliasing filtering unit and the motion-compensated image that is output from the MC unit according to the intraprediction/interprediction information extracted by the variable-length decoding unit;
a down-sampling unit which down-samples the image selected by the multiplexing unit at a first rate; and
an up-sampling unit which up-samples the down-sampled image stored in the frame buffering unit at a second rate in order to generate the reference image.
